(19) United States
(12) Patent Application Publication
(10) Pub. No.: US 2026/0008287 A1
(43) Pub. Date: Jan. 8, 2026

(54) PRINTING APPARATUS AND CONTROL METHOD FOR PRINTING APPARATUS

(71) Applicant: SEIKO EPSON CORPORATION, Tokyo (JP)

(72) Inventors: Koji YAMADA, OKAYA-SHI (JP); Hiroyoshi OKADA, MATSUMOTO-SHI (JP)

(21) Appl. No.: 19/257,762

(22) Filed: Jul. 2, 2025

(30) Foreign Application Priority Data
Jul. 5, 2024 (JP) 2024-108724

(51) Int. Cl. B41J 29/38; B41J 11/42; B41J 13/00; H04N 1/00

(52) U.S. Cl. CPC B41J 29/38; B41J 11/425; B41J 13/0009; H04N 1/0057

(57) ABSTRACT

A printer includes a drive motor, a conveyance roller driven by the drive motor to convey a recording medium, a recording head configured to perform printing on the recording medium, and a drive control unit configured to control the drive motor with PWM control. The drive control unit controls a duty ratio of the PWM control based on first conveyance speed, which is conveyance speed of the recording medium set in advance.

The present application is based on, and claims priority from JP Application Serial Number 2024-108724, filed Jul. 5, 2024, the disclosure of which is hereby incorporated by reference herein in its entirety.

### BACKGROUND

### 1. Technical Field

The present disclosure relates to a printing apparatus and a control method for a printing apparatus.

### 2. Related Art

JP-A-2012-125928 discloses a printer in which a booster circuit that boosts a supply voltage is provided.
JP-A-2012-125928 is an example of the related art.

However, the technique described in JP-A-2012-125928 has a problem in that manufacturing cost increases because the booster circuit is provided.

### SUMMARY

According to an aspect of the present disclosure, there is provided a printing apparatus including: a drive motor; a conveyance roller driven by the drive motor to convey a recording medium; a recording head configured to perform printing on the recording medium; and a drive control unit configured to control the drive motor with PWM control, wherein the drive control unit controls a duty ratio of the PWM control based on first conveyance speed, which is conveyance speed of the recording medium set in advance.

### BRIEF DESCRIPTION OF THE DRAWINGS

FIG. 1 is a diagram illustrating an example of a configuration of a printer according to an embodiment.

FIG. 2 is a flowchart illustrating an example of processing of a control unit.

FIG. 3 is a flowchart illustrating an example of processing of first control.

FIG. 4 is a flowchart illustrating an example of processing of second control.

FIG. 5 is a flowchart illustrating an example of processing of third control.

### DESCRIPTION OF EMBODIMENTS

An embodiment of the present disclosure is explained below with reference to the drawings.

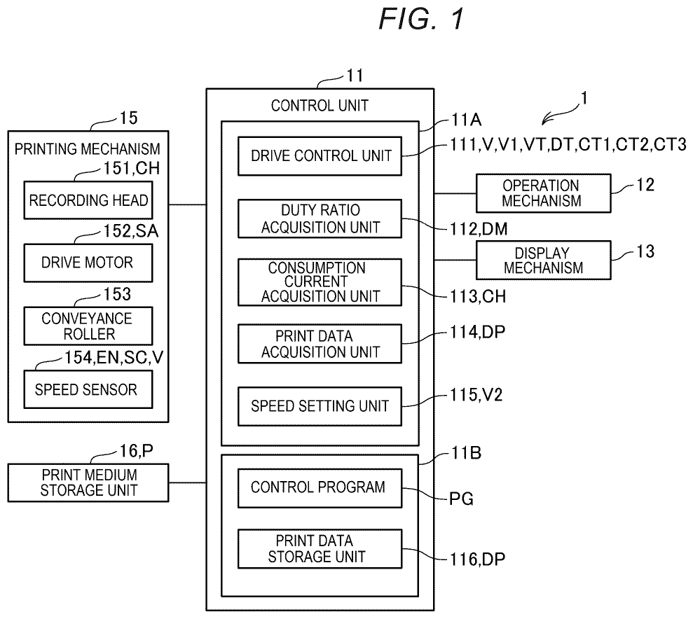

First, a configuration of a printer 1 according to the present embodiment is explained with reference to FIG. 1. FIG. 1 is a diagram illustrating an example of the configuration of the printer 1 according to the present embodiment.

As illustrated in FIG. 1, the printer 1 includes a control unit 11, an operation mechanism 12, a display mechanism 13, a printing mechanism 15, and a print medium storage unit 16.

The control unit 11 controls operations of the units of the printer 1. Each of the operation mechanism 12, the display mechanism 13, and the printing mechanism 15 is configured to be communicable with the control unit 11.

The printer 1 corresponds to an example of a “printing apparatus”.

The control unit 11 includes a processor 11A such as a central processing unit (CPU) and a memory 11B such as a read only memory (ROM). The memory 11B stores a control program PG.

The processor 11A may be configured by a plurality of processors or may be configured by a single processor.

The processor 11A may be hardware programmed to implement functions of the units explained below. That is, the processor 11A may have a configuration in which the control program PG is installed as a hardware circuit. In this case, for example, the processor 11A is configured by an application specific integrated circuit (ASIC), a field-programmable gate array (FPGA) or the like.

In the following explanation, a case in which the processor 11A executes the control program PG to thereby implement various functions of the control unit 11 is explained.

The memory 11B includes a nonvolatile storage area where programs and data are stored in a nonvolatile manner. The memory 11B may include, for example, a ROM, a hard disk drive (HDD), or a solid state drive (SSD) as the nonvolatile storage area. The memory 11B may include a volatile storage area and configure a work area temporarily storing programs to be executed by the processor 11A and processing target data. The memory 11B may include, for example, a random access memory (RAM) as the volatile storage area.

In the present embodiment, the processor 11A executes the control program PG to control the units of the printer 1 but is not limited thereto. The control unit 11 may include, for example, an ASIC. The ASIC may execute processing with functions implemented therein. The control unit 11 may include, for example, a signal processing circuit. The signal processing circuit may perform signal processing to execute the processing.

The operation mechanism 12 includes input units such as operation switches and a touch panel provided in the printer 1, detects operation on the input units by a user, and outputs a detection signal corresponding to the operation to the control unit 11. The control unit 11 executes processing corresponding to the operation by the user based on input from the operation mechanism 12.

The display mechanism 13 includes a plurality of light emitting diodes (LEDs) and a display panel such as a liquid crystal display (LCD) and executes lighting, extinction, and flashing of the LEDs in predetermined modes, display of information on the display panel, and the like according to control of the control unit 11.

Electric power is supplied to the printer 1 from a commercial power supply.

An AC voltage of the commercial power supply is converted into a DC voltage and electric power is supplied to, for example, a recording head 151 and a drive motor 152 of the printing mechanism 15. A voltage value of the DC voltage is set as appropriate according to a target to which electric power is supplied.

The control unit 11 controls the drive motor 152 with pulse width modulation (PWM) control. In other words, the control unit 11 controls the drive motor 152 by performing the PWM control on the DC voltage.

The printing mechanism 15 executes a printing function according to the control of the control unit 11. The printing mechanism 15 prints characters, images, and the like on a recording medium P such as printing paper according to the control of the control unit 11. The recording medium P is, for example, thermal paper.

The printing mechanism 15 includes the recording head 151, the drive motor 152, a conveyance roller 153, and a speed sensor 154 as components relating to printing.

The recording head 151 is a thermal head. That is, in the present embodiment, the printer 1 is a thermal printer.

The recording head 151 includes a plurality of heating elements. The plurality of heating elements generate heat by being energized. An image is formed on the recording medium P by applying heat to the recording medium P from the recording head 151.

A current sensor that detects a consumption current CH of the recording head 151 is disposed in the recording head 151. The current sensor outputs the detected consumption current CH to the control unit 11.

The drive motor 152 drives the conveyance roller 153. The drive motor 152 is, for example, a DC motor.

The conveyance roller 153 is disposed to face the recording head 151. The recording medium P is conveyed by rotation of the conveyance roller 153 in a state in which the conveyance roller 153 and the recording head 151 hold the recording medium P.

The speed sensor 154 detects conveyance speed V of the recording medium P.

The speed sensor 154 includes, for example, an encoder EN and a scale SC.

The encoder EN detects a rotation angle of the conveyance roller 153 to thereby detect the conveyance speed V of the recording medium P.

As the encoder EN, there are four types of a mechanical type, an optical type, a magnetic type, and an electromagnetic induction type. In the present embodiment, a case in which the encoder EN is, for example, the optical type is explained.

The encoder EN counts the number of substantially rectangular notches formed around the scale SC. The scale SC rotates integrally with a shaft of the conveyance roller 153. The scale SC is formed in a disk shape and the substantially rectangular notches are formed around the scale SC. In the scale SC, for example, 760 notches are formed at equal intervals.

The print medium storage unit 16 is configured to be capable of storing the recording medium P. For example, a roll body obtained by winding a long recording medium P into a roll shape is stored in the print medium storage unit 16, the recording medium P is pulled out from the roll body, is conveyed by the drive motor 152, and is let out to a not-illustrated conveyance path. The print medium storage unit 16 may include a component that collects a print, which is the recording medium P after printing.

Subsequently, functional blocks included in the control unit 11 of the printer 1 are explained.

The control unit 11 includes a drive control unit 111, a duty ratio acquisition unit 112, a consumption current acquisition unit 113, a print data acquisition unit 114, a speed setting unit 115, and a print data storage unit 116. The processor 11A executes the control program PG to thereby function as the drive control unit 111, the duty ratio acquisition unit 112, the consumption current acquisition unit 113, the print data acquisition unit 114, and the speed setting unit 115. The processor 11A executes the control program PG to thereby cause the memory 11B to function as the print data storage unit 116.

The print data storage unit 116 stores print data DP. The print data DP is acquired by the print data acquisition unit 114. The print data DP is stored in the print data storage unit 116 by the print data acquisition unit 114.

The print data DP is transmitted to the recording head 151 by the control unit 11. Then, an image corresponding to the print data DP is formed on the recording medium P by the recording head 151.

The drive control unit 111 controls the drive motor 152 with the PWM control.

The drive control unit 111 controls a duty ratio DT of the PWM control based on first conveyance speed V1, which is the conveyance speed V of the recording medium P set in advance. The first conveyance speed V1 is, for example, “150 mm/sec”.

The drive control unit 111 executes first control CT1, after starting driving of the drive motor 152, until the conveyance speed V reaches the first conveyance speed V1. The first control CT1 indicates that the duty ratio DT in the PWM control is increased such that the conveyance speed V increases.

In the first control CT1, the duty ratio DT is gradually increased. In the first control CT1, for example, the duty ratio DT is increased by a predetermined amount in one control cycle. The predetermined amount is, for example, “0.1%”.

The duty ratio acquisition unit 112 measures the duty ratio DT of the drive current applied to the drive motor 152 and calculates a measurement duty ratio DM, which is the measured duty ratio DT.

The duty ratio acquisition unit 112 corresponds to an example of an “acquisition unit”.

The duty ratio acquisition unit 112 calculates, as the measurement duty ratio DM, an average value obtained by performing averaging processing on a plurality of measured values of the duty ratio DT corresponding to a plurality of cycles in a current waveform. The plurality of measured values are, for example, five measured values.

That is, the measurement duty ratio DM is, for example, an average value obtained by performing averaging processing on five measured values of the duty ratio DT corresponding to five cycles in the current waveform. One cycle of the current waveform is, for example, “200 μsec”.

After the conveyance speed V reaches the first conveyance speed V1, the drive control unit 111 executes any one of the first control CT1, second control CT2, and third control CT3 based on the measurement duty ratio DM.

For example, when the measurement duty ratio DM is smaller than a first threshold TH1, the drive control unit 111 executes the first control CT1. The first threshold TH1 is, for example, “85%”.

For example, when the measurement duty ratio DM is equal to or larger than the first threshold TH1 and smaller than a second threshold TH2, the drive control unit 111 executes the second control CT2.

The second threshold TH2 is larger than the first threshold TH1. The second threshold TH2 is a value smaller than 100% by a predetermined value or more. The predetermined value is, for example, “3%”. The second threshold TH2 is, for example, “95%”.

The second control CT2 indicates that the duty ratio DT is controlled to maintain the conveyance speed V. For example, the second control CT2 controls the duty ratio DT to maintain the conveyance speed V at the first conveyance speed V1.

For example, when the measurement duty ratio DM is equal to or larger than the second threshold TH2, the drive control unit 111 executes the third control CT3. The third control CT3 indicates that the duty ratio DT is controlled such that the conveyance speed V decreases.

In the third control CT3, the duty ratio DT is gradually reduced. In the third control CT3, for example, the duty ratio DT is reduced by a predetermined amount in one control cycle. The predetermined amount is, for example, “0.1%”.

When the measurement duty ratio DM is equal to or larger than a third threshold TH3 during the execution of the first control CT1, the drive control unit 111 stops the first control CT1 and executes the second control CT2. In this case, in the second control CT2, the drive control unit 111 controls the duty ratio DT to maintain the conveyance speed V when the measurement duty ratio DM is equal to or larger than the third threshold TH3.

The third threshold TH3 is larger than the first threshold TH1 and smaller than the second threshold TH2. The third threshold TH3 is, for example, “90%”.

When the measurement duty ratio DM is equal to or smaller than a fourth threshold TH4 during the execution of the third control CT3, the drive control unit 111 stops the third control CT3 and executes the second control CT2. In this case, in the second control CT2, the drive control unit 111 controls the duty ratio DT to maintain the conveyance speed V when the measurement duty ratio DM is equal to or smaller than the fourth threshold TH4.

The fourth threshold TH4 is larger than the first threshold TH1 and smaller than the second threshold TH2. The fourth threshold TH4 is, for example, “90%”.

The consumption current acquisition unit 113 acquires the consumption current CH of the recording head 151 while the drive control unit 111 is executing the first control CT1, the second control CT2, or the third control CT3.

While the drive control unit 111 is executing the first control CT1, the second control CT2, or the third control CT3, the print data acquisition unit 114 acquires the print data DP indicating a print image to be printed on the recording medium P. The consumption current acquisition unit 113 acquires the print data DP from, for example, a point of sale (POS) terminal device communicably connected to the printer 1.

The speed setting unit 115 sets second conveyance speed V2 lower than the first conveyance speed V1 based on the consumption current CH acquired by the consumption current acquisition unit 113. The speed setting unit 115 sets the second conveyance speed V2 to lower speed as the consumption current CH is larger.

When the second conveyance speed V2 is equal to or smaller than speed threshold THV, the drive control unit 111 controls the duty ratio DT to maintain the conveyance speed V at the second conveyance speed V2. The speed threshold THV is a speed slower than the first conveyance speed V1. The speed threshold THV is, for example, “140 mm/sec”.

The speed setting unit 115 sets third conveyance speed V3 lower than the first conveyance speed V1 based on the print data DP acquired by the print data acquisition unit 114. The speed setting unit 115 sets the third conveyance speed V3 to lower speed as the number of heating elements energized when printing the print data DP is larger.

When the third conveyance speed V3 is equal to or smaller than the speed threshold THV, the drive control unit 111 controls the duty ratio DT to maintain the conveyance speed V at the third conveyance speed V3. The speed threshold THV is a speed slower than the first conveyance speed V1. The speed threshold THV is, for example, “140 mm/sec”.

In the present embodiment, a case in which the conveyance speed V is limited to the second conveyance speed V2 and the third conveyance speed V3, which are lower than the first conveyance speed V1, based on the consumption current CH of the recording head 151 and the print data DP is explained. However, the embodiment is not limited thereto. For example, when the temperature of the drive motor 152 is equal to or higher than a predetermined temperature, the drive control unit 111 may limit the conveyance speed V to a speed lower than the first conveyance speed V1.

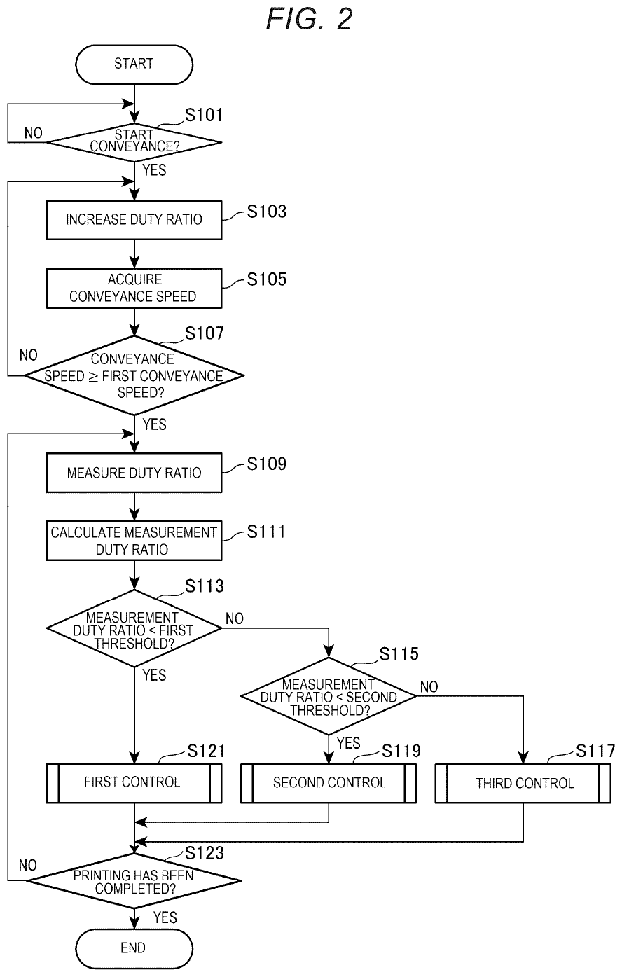

Subsequently, processing of the control unit 11 in the present embodiment is explained with reference to FIG. 2. FIG. 2 is a flowchart illustrating an example of the processing of the control unit 11.

As illustrated in FIG. 2, first, in step S101, the control unit 11 determines whether conveyance of the recording medium P is started. For example, the control unit 11 determines, based on the conveyance speed V of the recording medium P detected by the speed sensor 154, whether conveyance of the recording medium P is started.

When the control unit 11 determines that conveyance of the recording medium P is not started (step S101; NO), the processing comes into a standby state. When the control unit 11 determines that conveyance of the recording medium P is started (step S101; YES), the processing proceeds to step S103.

Then, in step S103, the drive control unit 111 increases the duty ratio DT in the PWM control.

Subsequently, in step S105, the drive control unit 111 acquires the conveyance speed V from the speed sensor 154.

Subsequently, in step S107, the drive control unit 111 determines whether the conveyance speed V is equal to or higher than the first conveyance speed V1.

When the drive control unit 111 determines that the conveyance speed V is not equal to or higher than the first conveyance speed V1 (step S107; NO), the processing returns to step S103. When the drive control unit 111 determines that the conveyance speed V is equal to or higher than the first conveyance speed V1 (step S107; YES), the processing proceeds to step S109.

In step S109, the duty ratio acquisition unit 112 measures the duty ratio DT of the drive current applied to the drive motor 152.

Subsequently, in step S111, the duty ratio acquisition unit 112 calculates the measurement duty ratio DM. The measurement duty ratio DM is, for example, an average value obtained by performing averaging processing on five measured values of the duty ratio DT corresponding to five cycles in a current waveform of the drive current applied to the drive motor 152.

Subsequently, in step S113, the drive control unit 111 determines whether the measurement duty ratio DM is smaller than the first threshold TH1. The first threshold TH1 is, for example, “85%”.

When the drive control unit 111 determines that the measurement duty ratio DM is smaller than the first threshold TH1 (step S113; YES), the processing proceeds to step S121. When the drive control unit 111 determines that the measurement duty ratio DM is not smaller than the first threshold TH1 (step S113; NO), the processing proceeds to step S115.

Then, in step S115, the drive control unit 111 determines whether the measurement duty ratio DM is smaller than the second threshold TH2. The second threshold TH2 is, for example, “95%”.

When the drive control unit 111 determines that the measurement duty ratio DM is not smaller than the second threshold TH2 (step S115; NO), the processing proceeds to step S117.

Then, in step S117, the drive control unit 111 executes the third control CT3. Thereafter, the processing proceeds to step S123.

When the drive control unit 111 determines that the measurement duty ratio DM is smaller than the second threshold TH2 (step S115; YES), the processing proceeds to step S119.

Then, in step S119, the drive control unit 111 executes the second control CT2. Thereafter, the processing proceeds to step S123.

In the case of YES in step S113, in step S121, the drive control unit 111 executes the first control CT1. Thereafter, the processing proceeds to step S123.

Subsequently, in step S123, the control unit 11 determines whether the printing has been completed.

When the control unit 11 determines that the printing has not been completed (step S123; NO), the processing returns to step S109. When the control unit 11 determines that the printing has been completed (step S123; YES), the control unit 11 stops the drive current applied to the drive motor 152 and ends the processing.

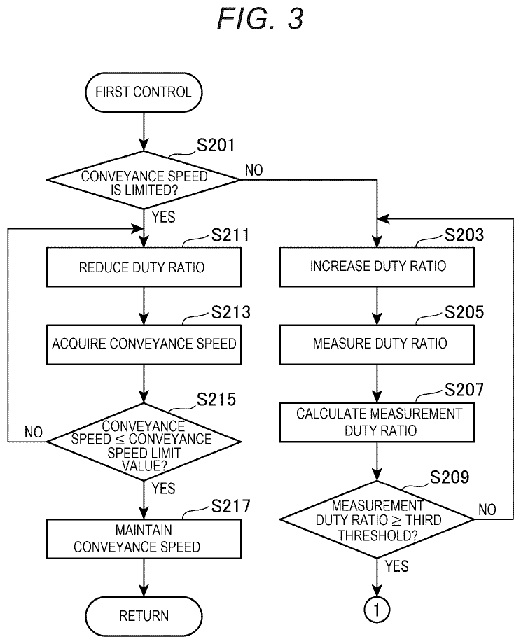

Subsequently, the processing of the first control CT1 executed in step S121 in FIG. 2 is explained with reference to FIG. 3. FIG. 3 is a flowchart illustrating an example of the processing of the first control CT1.

As illustrated in FIG. 3, first, in step S201, the control unit 11 determines whether the conveyance speed V is limited.

As explained with reference to FIG. 1, the limitation of the conveyance speed V indicates that the conveyance speed V is limited to speed lower than the first conveyance speed V1 based on the consumption current CH of the recording head 151, the print data DP, the temperature of the drive motor 152, and the like. The speed lower than the first conveyance speed V1 is described as “conveyance speed limit value VR”. Each of the second conveyance speed V2 and the third conveyance speed V3 explained with reference to FIG. 1 corresponds to an example of the conveyance speed limit value VR.

When the control unit 11 determines that the conveyance speed V is limited (step S201; YES), the processing proceeds to step S211. When the control unit 11 determines that the conveyance speed V is not limited (step S201; NO), the processing proceeds to step S203.

Then, in step S203, the drive control unit 111 increases the duty ratio DT in the PWM control.

Subsequently, in step S205, the duty ratio acquisition unit 112 measures the duty ratio DT of the drive current applied to the drive motor 152.

Subsequently, in step S207, the duty ratio acquisition unit 112 calculates the measurement duty ratio DM.

Subsequently, in step S209, the drive control unit 111 determines whether the measurement duty ratio DM is equal to or larger than the third threshold TH3. The third threshold TH3 is, for example, “90%”.

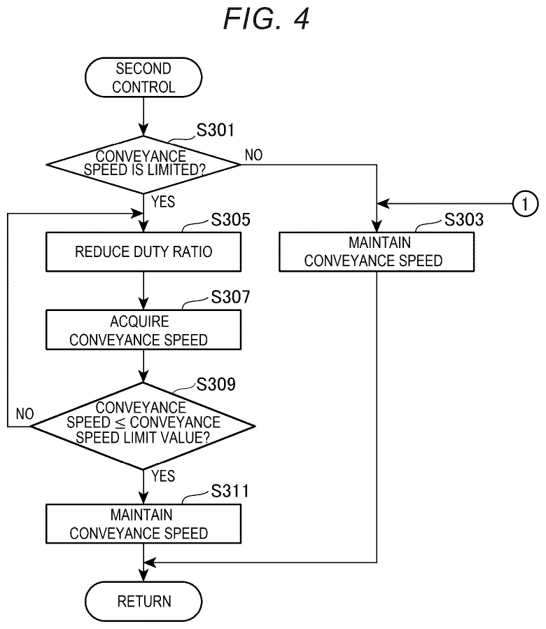

When the drive control unit 111 determines that the measurement duty ratio DM is not equal to or larger than the third threshold TH3 (step S209; NO), the processing returns to step S203. When the drive control unit 111 determines that the measurement duty ratio DM is equal to or larger than the third threshold TH3 (step S209; YES), the processing proceeds to step S303 in the second control CT2 illustrated in FIG. 4.

In the case of YES in step S201, in step S211, the drive control unit 111 reduces the duty ratio DT in the PWM control.

Subsequently, in step S213, the drive control unit 111 acquires the conveyance speed V from the speed sensor 154.

Subsequently, in step S215, the drive control unit 111 determines whether the conveyance speed V is equal to or smaller than the conveyance speed limit value VR.

When the drive control unit 111 determines that the conveyance speed V is not equal to or smaller than the conveyance speed limit value VR (step S215; NO), the processing returns to step S211. When the drive control unit 111 determines that the conveyance speed V is equal to or smaller than the conveyance speed limit value VR (step S215; YES), the processing proceeds to step S217.

Then, in step S217, the drive control unit 111 controls the duty ratio DT in the PWM control to maintain the conveyance speed V. Thereafter, the processing is returned to step S123 in FIG. 2.

Subsequently, the processing of the second control CT2 executed in step S119 in FIG. 2 is explained with reference to FIG. 4. FIG. 4 is a flowchart illustrating an example of the processing of the second control CT2.

As illustrated in FIG. 4, first, in step S301, the control unit 11 determines whether the conveyance speed V is limited.

When the control unit 11 determines that the conveyance speed V is limited (step S301; YES), the processing proceeds to step S305. When the control unit 11 determines that the conveyance speed V is not limited (step S301; NO), the processing proceeds to step S303.

Then, in step S303, the drive control unit 111 controls the duty ratio DT in the PWM control to maintain the conveyance speed V. Thereafter, the processing is returned to step S123 in FIG. 2.

In the case of YES in step S301, in step S305, the drive control unit 111 reduces the duty ratio DT in the PWM control.

Subsequently, in step S307, the drive control unit 111 acquires the conveyance speed V from the speed sensor 154.

Subsequently, in step S309, the drive control unit 111 determines whether the conveyance speed V is equal to or smaller than the conveyance speed limit value VR.

When the drive control unit 111 determines that the conveyance speed V is not equal to or smaller than the conveyance speed limit value VR (step S309; NO), the processing returns to step S305. When the drive control unit 111 determines that the conveyance speed V is equal to or smaller than the conveyance speed limit value VR (step S309; YES), the processing proceeds to step S311.

Then, in step S311, the drive control unit 111 controls the duty ratio DT in the PWM control to maintain the conveyance speed V. Thereafter, the processing is returned to step S123 in FIG. 2.

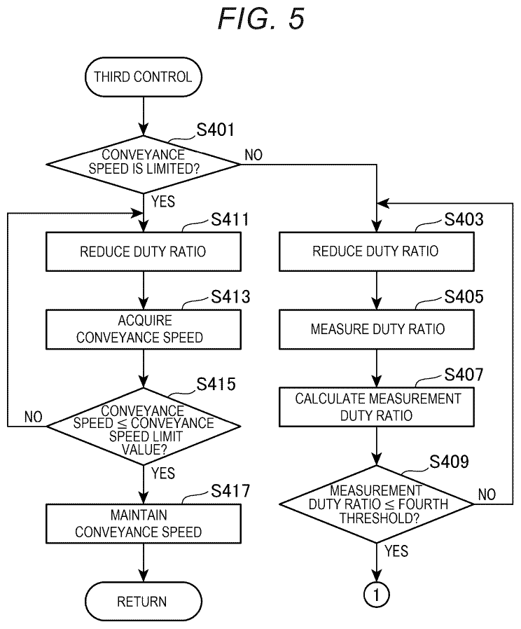

Subsequently, the processing of the third control CT3 executed in step S117 in FIG. 2 is explained with reference to FIG. 5. FIG. 5 is a flowchart illustrating an example of the processing of the third control CT3.

As illustrated in FIG. 5, first, in step S401, the control unit 11 determines whether the conveyance speed V is limited.

When the control unit 11 determines that the conveyance speed V is limited (step S401; YES), the processing proceeds to step S411. When the control unit 11 determines that the conveyance speed V is not limited (step S401; NO), the processing proceeds to step S403.

Then, in step S403, the drive control unit 111 reduces the duty ratio DT in the PWM control.

Subsequently, in step S405, the duty ratio acquisition unit 112 measures the duty ratio DT of the drive current applied to the drive motor 152.

Subsequently, in step S407, the duty ratio acquisition unit 112 calculates the measurement duty ratio DM.

Subsequently, in step S409, the drive control unit 111 determines whether the measurement duty ratio DM is equal to or smaller than the fourth threshold TH4. The fourth threshold TH4 is, for example, “90%”.

When the drive control unit 111 determines that the measurement duty ratio DM is not equal to or smaller than the fourth threshold TH4 (step S409; NO), the processing returns to step S403. When the drive control unit 111 determines that the measurement duty ratio DM is equal to or smaller than the fourth threshold TH4 (step S409; YES), the processing proceeds to step S303 in the second control CT2 illustrated in FIG. 4.

In the case of YES in step S401, in step S411, the drive control unit 111 reduces the duty ratio DT in the PWM control.

Subsequently, in step S413, the drive control unit 111 acquires the conveyance speed V from the speed sensor 154.

Subsequently, in step S415, the drive control unit 111 determines whether the conveyance speed V is equal to or smaller than the conveyance speed limit value VR.

When the drive control unit 111 determines that the conveyance speed V is not equal to or smaller than the conveyance speed limit value VR (step S415; NO), the processing returns to step S411. When the drive control unit 111 determines that the conveyance speed V is equal to or smaller than the conveyance speed limit value VR (step S415; YES), the processing proceeds to step S417.

Then, in step S417, the drive control unit 111 controls the duty ratio DT in the PWM control to maintain the conveyance speed V. Thereafter, the processing is returned to step S123 in FIG. 2.

### Configurations and Effects

As explained above with reference to FIGS. 1 to 5, the printer 1 according to the present embodiment includes the drive motor 152, the conveyance roller 153 driven by the drive motor 152 to convey the recording medium P, the recording head 151 that performs printing on the recording medium P, and the drive control unit 111 that controls the drive motor 152 with the PWM control. The drive control unit 111 controls the duty ratio DT of the PWM control based on the first conveyance speed V1 that is the conveyance speed V of the recording medium P set in advance.

With this configuration, since the duty ratio DT of the PWM control is controlled based on the first conveyance speed V1, it is possible to control the conveyance speed V of the recording medium P by the drive motor 152 without providing a booster circuit in the printer 1. By setting the first conveyance speed V1 to a proper value, it is possible to properly control the conveyance speed V of the recording medium P by the drive motor 152.

The printer 1 according to the present embodiment includes the speed sensor 154 that detects the conveyance speed V of the recording medium P. The drive control unit 111 executes the first control CT1 of increasing the duty ratio DT in the PWM control such that the conveyance speed V increases, after starting the driving of the drive motor 152, until the conveyance speed V reaches the first conveyance speed V1.

With this configuration, since the first control CT1 of increasing the duty ratio DT in the PWM control is executed such that the conveyance speed V increases, after starting the driving of the drive motor 152, until the conveyance speed V reaches the first conveyance speed V1, it is possible to properly control the conveyance speed V.

The printer 1 according to the present embodiment includes the duty ratio acquisition unit 112 that measures the duty ratio DT and acquires the measurement duty ratio DM, which is the measured duty ratio. After the conveyance speed V reaches the first conveyance speed V1, the drive control unit 111 executes the first control CT1 when the measurement duty ratio DM is smaller than the first threshold TH1, when the measurement duty ratio DM is equal to or larger than the first threshold TH1 and smaller than the second threshold TH2 larger than the first threshold TH1, executes the second control CT2 for controlling the duty ratio DT to maintain the conveyance speed V, and, when the measurement duty ratio DM is equal to or larger than the second threshold TH2, executes the third control CT3 for controlling the duty ratio DT to reduce the conveyance speed V.

With this configuration, it is possible to control the duty ratio DT such that the measurement duty ratio DM is equal to or larger than the first threshold TH1 and smaller than the second threshold TH2 larger than the first threshold TH1. Therefore, it is possible to prevent the duty ratio DT from reaching, for example, 100% to make it difficult to control the conveyance speed V. By setting the values of the first threshold TH1 and the second threshold TH2 to proper values, it is possible to properly prevent the duty ratio DT from reaching, for example, 100% to make it difficult to control the conveyance speed V.

In the printer 1 according to the present embodiment, the second threshold TH2 is a value smaller than 100% by a predetermined value or more.

With this configuration, since the second threshold TH2 is the value smaller than 100% by the predetermined value or more, by setting the predetermined value to a proper value, it is possible to securely prevent the duty ratio DT from reaching, for example, 100% to make it difficult to control the conveyance speed V.

In the printer 1 according to the present embodiment, the duty ratio acquisition unit 112 acquires, as the measurement duty ratio DM, an average value obtained by performing averaging processing on a plurality of measured values of the duty ratio DT corresponding to a plurality of cycles in a current waveform of a drive current of the drive motor 152.

With this configuration, since the average value obtained by performing the averaging processing on the plurality of measured values of the duty ratio DT corresponding to the plurality of cycles in the current waveform of the drive current of the drive motor 152 is acquired as the measurement duty ratio DM, it is possible to reduce the influence of noise included in the current waveform. Therefore, it is possible to properly calculate the measurement duty ratio DM.

In the printer 1 according to the present embodiment, when, during the execution of the first control CT1, the measurement duty ratio DM is equal to or larger than the third threshold TH3 that is larger than the first threshold TH1 and smaller than the second threshold TH2, the drive control unit 111 stops the first control CT1 and executes the second control CT2.

With this configuration, it is possible to transition from the first control CT1 to the second control CT2 at proper timing. By setting the third threshold TH3 to a proper value, it is possible to transition from the first control CT1 to the second control CT2 at more proper timing.

In the printer 1 according to the present embodiment, the drive control unit 111 stops the third control CT3 and executes the second control CT2 when, during the execution of the third control CT3, the measurement duty ratio DM is equal to or smaller than the fourth threshold TH4 that is larger than the first threshold TH1 and smaller than the second threshold TH2.

With this configuration, it is possible to transition from the third control CT3 to the second control CT2 at proper timing. By setting the fourth threshold TH4 to proper value, it is possible to transition from the third control CT3 to the second control CT2 at more proper timing.

In the printer 1 according to the present embodiment, the recording head 151 is the thermal head. The printer 1 includes the speed setting unit 115 that sets the second conveyance speed V2 lower than the first conveyance speed V1 based on the consumption current CH of the recording head 151 during the execution of the first control CT1, the second control CT2, or the third control CT3. When the second conveyance speed V2 is equal to or smaller than the speed threshold THV, the drive control unit 111 controls the duty ratio DT to maintain the conveyance speed V at the second conveyance speed V2.

With this configuration, since the second conveyance speed V2 lower than the first conveyance speed V1 is set based on the consumption current CH of the recording head 151, it is possible to properly reduce the conveyance speed V when the consumption current CH of the recording head 151 is large. Therefore, it is possible to prevent power consumption of the printer 1 from exceeding electric power that can be supplied.

In the printer 1 according to the present embodiment, the recording head 151 is the thermal head. The printer 1 includes the speed setting unit 115 that sets the third conveyance speed V3 lower than the first conveyance speed V1 based on the print data DP indicating a print image, which is printed on the recording medium P, during execution of the first control CT1, the second control CT2, or the third control CT3. When the third conveyance speed V3 is equal to or lower than the speed threshold THV, the drive control unit 111 controls the duty ratio DT to maintain the conveyance speed V at the third conveyance speed V3.

With this configuration, it is possible to properly reduce the conveyance speed V based on the print data DP before the consumption current CH of the recording head 151 increases because the number of heating elements that generate heat increases. Therefore, it is possible to securely prevent power consumption of the printer 1 from exceeding electric power that can be supplied.

A control method for the printer 1 according to the present embodiment is a control method for the printer 1 including the drive motor 152, the conveyance roller 153 driven by the drive motor 152 to convey the recording medium P, and the recording head 151 that performs printing on the recording medium P, the method includes controlling the drive motor 152 by controlling the duty ratio DT of the PWM control based on the first conveyance speed V1, which is the conveyance speed V of the recording medium P set in advance.

The control method for the printer 1 according to the present embodiment has the same action effects as the action effects of the printer 1 according to the present embodiment.

### OTHER EMBODIMENTS

The present embodiment shows one aspect and any modifications and applications can be made thereto without departing from the spirit and scope of the present disclosure.

In the present embodiment, a case in which the “printing apparatus” is the printer 1 is explained. However, the embodiment is not limited thereto. The “printing apparatus” may be, for example, a copying machine. The “printing apparatus” may be, for example, a so-called multifunction peripheral.

In the present embodiment, a case in which the recording head 151 is the thermal head is explained. However, the embodiment is not limited thereto. The recording head 151 may be, for example, a head that ejects ink.

In the present embodiment, a case in which the processor 11A provided in the printer 1 executes the control program PG stored in the memory 11B is explained. However, the embodiment is not limited thereto. It is also possible to configure the control program PG in a form of a recording medium computer-readably recording the control program PG or a transmission medium for transmitting the control program PG.

As the recording medium, a magnetic or optical recording medium or a semiconductor memory device can be used. The recording medium may be a portable or stationary recording medium such as a flexible disc, an HDD, a compact disk read-only memory (CD-ROM), a digital versatile disk (DVD), a Blu-ray (trademark registered) disc, a magneto-optical disc, a flash memory, or a card-type recording medium.

The recording medium may be a nonvolatile storage device such as a RAM, a ROM, or an HDD, which is an internal storage device provided in the printer 1.

The functions of the control unit 11 of the printer 1 may be implemented by one or a plurality of processors or a semiconductor chip. The control unit 11 may further include a co-processor such as a system-on-a-chip (SoC), a micro control unit (MCU), or an FPGA. The control unit 11 may perform various kinds of control by causing the CPU and the co-processor to cooperate with each other or selectively using one of the CPU and the co-processor.

Processing units of each of the flowcharts in FIGS. 2 to 5 are provided by dividing the processing of the control unit 11 of the printer 1 according to the main processing content in order to facilitate the understanding of the processing and are not limited by a dividing method and names of the processing units. The processing units in the flowchart may be divided into a larger number of processing units according to the processing content. The processing units may also be divided such that one processing unit includes a larger number of kinds of processing. The order of the processing may be changed as appropriate as long as the gist of the present disclosure is not hindered.

The functional units illustrated in FIG. 1 represents functional components and specific implementation forms thereof are not particularly limited. Hardware individually corresponding to the functional units does not always be implemented. The functions of the plurality of functional units can be implemented by a single processor executing a program. Some of functions implemented by software in the embodiment explained above may be implemented by hardware or some of functions implemented by hardware may be implemented by software. Besides, specific detailed configurations of the other units of the printer 1 can be optionally changed without departing from the gist.

What is claimed is:

1. A printing apparatus comprising:
a drive motor;
a conveyance roller driven by the drive motor to convey a recording medium;
a recording head configured to perform printing on the recording medium; and
a drive control unit configured to control the drive motor with PWM control, wherein
the drive control unit controls a duty ratio of the PWM control based on first conveyance speed, which is conveyance speed of the recording medium set in advance.

2. The printing apparatus according to claim 1, further comprising a speed sensor configured to detect the conveyance speed of the recording medium, wherein
the drive control unit executes first control of increasing the duty ratio in the PWM control such that the conveyance speed increases, after starting the driving of the drive motor, until the conveyance speed reaches the first conveyance speed.

3. The printing apparatus according to claim 2, further comprising an acquisition unit configured to measure the duty ratio and acquire a measurement duty ratio, which is a measured duty ratio, wherein
after the conveyance speed reaches the first conveyance speed, the drive control unit
executes the first control when the measurement duty ratio is smaller than a first threshold,
when the measurement duty ratio is equal to or larger than the first threshold and smaller than a second threshold larger than the first threshold, executes second control of controlling the duty ratio to maintain the conveyance speed, and
when the measurement duty ratio is equal to or larger than the second threshold, executes third control of controlling the duty ratio to reduce the conveyance speed.

4. The printing apparatus according to claim 3, wherein the second threshold is a value smaller than 100% by a predetermined value or more.

5. The printing apparatus according to claim 3, wherein the acquisition unit acquires, as the measurement duty ratio, an average value obtained by performing averaging processing on a plurality of measured values of the duty ratio corresponding to a plurality of cycles in a current waveform of a drive current of the drive motor.

6. The printing apparatus according to claim 3, wherein the drive control unit stops the first control and executes the second control when, during the execution of the first control, the measurement duty ratio is equal to or larger than a third threshold that is larger than the first threshold and smaller than the second threshold.

7. The printing apparatus according to claim 3, wherein the drive control unit stops the third control and executes the second control when, during the execution of the third control, the measurement duty ratio is equal to or smaller than a fourth threshold that is larger than the first threshold and smaller than the second threshold.

8. The printing apparatus according to claim 3, wherein
the recording head is a thermal head,
the printing apparatus further comprises a speed setting unit configured to set second conveyance speed lower than the first conveyance speed based on a consumption current of the recording head during the execution of the first control, the second control, or the third control, and
when the second conveyance speed is equal to or lower than a speed threshold, the drive control unit controls the duty ratio to maintain the conveyance speed at the second conveyance speed.

9. The printing apparatus according to claim 3, wherein
the recording head is a thermal head,
the printing apparatus further comprises a speed setting unit configured to set third conveyance speed lower than the first conveyance speed based on print data indicating a print image, which is printed on the recording medium, during the execution of the first control, the second control, or the third control, and
when the third conveyance speed is equal to or lower than a speed threshold, the drive control unit controls the duty ratio to maintain the conveyance speed at the third conveyance speed.

10. A control method for a printing apparatus including a drive motor, a conveyance roller driven by the drive motor to convey a recording medium, and a recording head configured to perform printing on the recording medium, the method comprising controlling the drive motor by controlling a duty ratio of PWM control based on first conveyance speed, which is conveyance speed of the recording medium set in advance.
